(19) United States
(12) Patent Application Publication
(10) Pub. No.: US 2003/0181096 A1
(43) Pub. Date: Sep. 25, 2003

(54) Structure of connector outer shell

(75) Inventor: Yen Wei Chiu, Taipei Hsien (TW)

Correspondence Address: BACON & THOMAS, PLLC, 625 SLATERS LANE, FOURTH FLOOR, ALEXANDRIA, VA, 22314

(73) Assignee: Kuon Yi Industrial Corp., Taipei Hsien (TW)

(21) Appl. No.: 10/101,590

(22) Filed: Mar. 21, 2002

(51) Int. Cl. H01R 13/60

(52) U.S. Cl. 439/567

(57) ABSTRACT

A connector outer shell is constructed to include a metal shell body electroplated with nickel and adapted for holding a connector, the shell body having mounting holes symmetrically disposed at two sides, and a plurality of mounting members adapted for fastening the shell body to a circuit board, each mounting member having a base, a curved retaining strip extended from the base and fastened to one mounting hole of the shell body, hooked portions extended from the base and hooked on the bottom edge of the shell body, and a leg extended from the base for soldering to a respective mounting hole of the cir4cuit board.

### BACKGROUND OF THE INVENTION

1. Field of the Invention

The present invention relates to electric connectors and, more specifically, to a structure of connector outer shell for an electric connector, which can conveniently easily soldered to a circuit board without damaging the coating of the shell.

2. Description of the Related Art

An electric connector is known comprising a frame covered with a meal outer shell, the frame having a plurality of receiving chambers separated by partition boards, and a plurality of connector bodies respectively mounted in the receiving chambers. The connector bodies have contact terminals extended out of the rear side of the frame. Further, the metal outer shell has plug rods for mounting. During installation of the electric connector in a circuit board, the plug rods are respectively plugged into respective mounting holes in the circuit board and then fixedly soldered thereto. Because the metal outer shell is tin-plated, high temperature will damage the coating of the metal outer shell and cause the metal outer shell to deform.

### SUMMARY OF THE INVENTION

The present invention has been accomplished to provide a connector outer shell, which eliminates the aforesaid problem. IT is the main object of the present invention to provide a connector outer shell, which can conveniently easily soldered to a circuit board without damaging the coating of the shell or causing the shell body to deform. According to the present invention, the connector outer shell is comprised of a metal shell body electroplated with nickel or chrome, and a plurality of metal mounting members adapted for fastening the shell body to a circuit board. The shell body has mounting holes symmetrically disposed at two sides. The metal mounting members each comprise a base, a curved retaining strip extended from the base and fastened to one mounting hole of the shell body, hooked portions extended from the base and hooked on the bottom edge of the shell body, and a leg extended from the base for soldering to a respective mounting hole of the cir4cuit board.

### BRIEF DESCRIPTION OF THE DRAWINGS

FIG. 1 is an exploded view of a connector outer shell according to the present invention.

FIG. 2 is an assembly view of the connector outer shell according to the present invention.

FIG. 3 illustrates a connector installed in the shell body of the connector outer shell according to the present invention.

### DETAILED DESCRIPTION OF THE PREFERRED EMBODIMENT

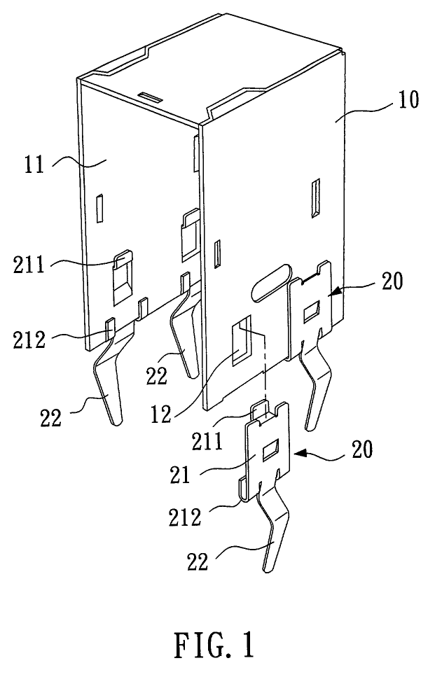

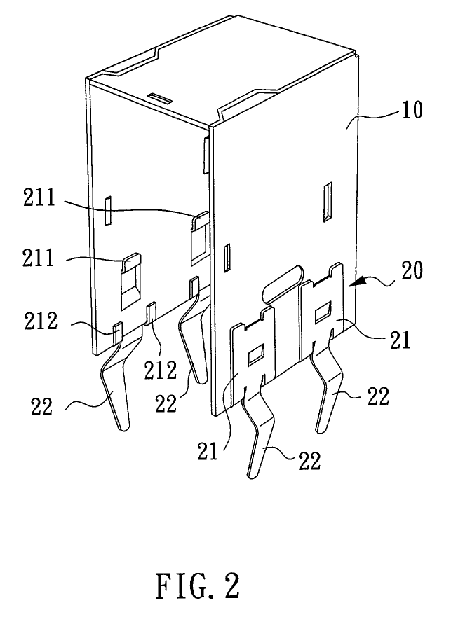

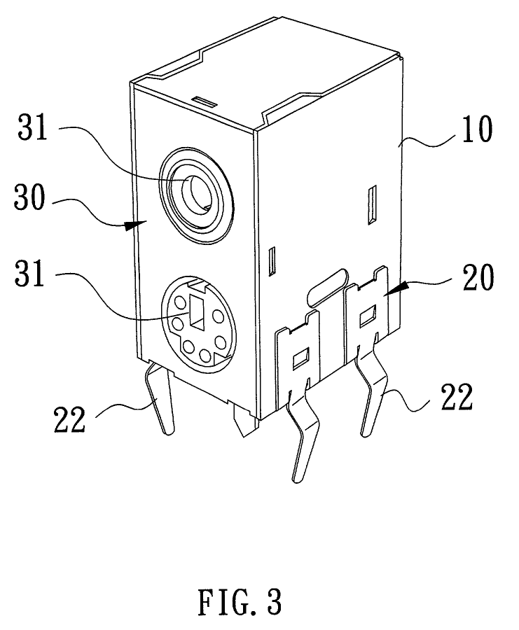

Referring to FIG. 1, a connector outer shell is shown comprised of a shell body 10 and a plurality of metal mounting members 20 respectively fastened to the shell body 10. The shell body 10 is an open frame coated with nickel or chrome, having a front opening 11 through which a connector 30 is inserted into the inside of the shell body 10 (see FIG. 3). The front opening 11 is in communication with the bottom open side of the connector outer shell 10. The shell body 10 further comprises a plurality of mounting holes, for example, two pairs of mounting holes 12 symmetrically disposed in two opposite side walls thereof for the mounting of the metal mounting members 20 respectively. The metal mounting members 20 each comprise a base 21, a leg 22 extended from one end of the base 21 for fastening to a circuit board (not shown), a curved retaining strip 211 extended from the opposite end of the base 21 and fastened to one mounting hole 12 of the shell body 10, and hooked portions 212 bilaterally extended from the connecting area between the base 21 and the leg 22 and respectively hooked on the bottom edge of the shell body 10 (see FIG. 2).

Referring to FIG. 3, the connector 30 is press-fitted through the front opening 11 into the inside of the shell body 10, having at least one, for example, two sockets 31 for receiving a respective matching connector, and a plurality of terminals (not shown) respectively extended from the sockets 31 over the bottom side thereof. During installation, the legs 22 of the mounting members 20 are respectively plugged into respective mounting holes in the circuit board and fixedly soldered thereto, keeping the terminals of the connector 30 in positive contact with respective contact holes in the circuit board. Because the shell body 10 is nickel-plated (or chrome-plated), soldering the legs 22 of the mounting members 20 to the respective mounting holes of the circuit board does not damage the coating of the shell body 10 or deform the shell body 10

A prototype of structure of connector outer shell has been constructed with the features of the annexed drawings of FIGS. 1˜3. The structure of connector outer shell functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A connector outer shell comprising:
a metal shell body adapted for holding a connector, said shell body having a front opening through which a connector is press-fitted into the inside of said shell body, a bottom open side, and a plurality of mounting holes symmetrically disposed in two opposite side walls thereof; and
a plurality of metal mounting members adapted for securing said metal shell body to a circuit board, said metal mounting members each comprising a base, a leg extended from one end of said base for fastening to respective mounting hole in a circuit board, a curved retaining strip extended from an opposite end of said base and fastened to one mounting hole of said shell body, and at least one hooked portion extended from the connecting area between said base and said leg and respectively hooked on a bottom edge of said shell body.

2. The connector outer shell as claimed in claim 1, wherein said metal shell body is electroplated with chrome.
